(19) United States
(12) Patent Application Publication
(10) Pub. No.: US 2025/0038437 A1
(43) Pub. Date: Jan. 30, 2025

(54) COMPACT RELIABLE RECEPTACLE CONNECTOR

(71) Applicant: Amphenol East Asia Electronic Technology (Shenzhen) Co., Ltd., Shenzhen (CN)

(72) Inventors: Zhimin Qin, Shenzhen (CN); Zefeng Lai, Shenzhen (CN)

(73) Assignee: Amphenol East Asia Electronic Technology (Shenzhen) Co., Ltd., Shenzhen (CN)

(21) Appl. No.: 18/783,690

(22) Filed: Jul. 25, 2024

(30) Foreign Application Priority Data
Jul. 26, 2023 (CN) 202321988693.0

(51) Int. Cl. H01R 12/70; H01R 13/52; H01R 43/00; H01R 43/20

(52) U.S. Cl. CPC H01R 12/7011; H01R 13/5202; H01R 13/5219; H01R 43/005; H01R 43/205

(57) ABSTRACT

A compact, reliable receptacle connector. The connector comprises terminals held by an assembly housing. A shell surrounds mating ends of the terminals and engages with the assembly housing. A housing is disposed outside the shell and partially encloses a rear of the shell. A board lock is also partially embedded in the housing. Such a configuration enables the connector to have a single shell and reduces the risk of relevant movements between the shell/board lock and the housing when, for example, a component is inserted into or removed from the connector. The connector can comprise a front seal disposed around a portion of the shell that extends beyond the housing, and a rear seal disposed between a top of the housing and a bottom of the shell. Such a configuration can effectively block ingress of environmental contaminants from both the front and the rear.

### CROSS-REFERENCE TO RELATED APPLICATIONS

This application claims priority to and the benefit of Chinese Patent Application Serial No. 202321988693.0, filed on Jul. 26, 2023, the contents of which are incorporated herein by reference in their entirety.

### TECHNICAL FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several electronic subassemblies is to have one printed circuit board serve as a backplane. A known backplane is a PCB onto which many connectors may be mounted. Conducting traces in the backplane may be electrically connected to signal conductors in the connectors such that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

Connectors may also be used in computers in which the motherboard might have a processor and a bus configured to pass data between the processor and peripherals, such as a printer or memory device. Connectors may be mounted to the motherboard and connected to the bus. A mating interface of those connectors may be exposed through an opening in the enclosure for the computer, such that connectors, often attached to the peripheral through a cable, may be inserted into the connectors on the motherboard. With this configuration, a peripheral can be easily connected to a computer.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include universal serial bus (USB), which is commonly used in computers. The standards have gone through multiple revisions, adapting to the higher performance expected from computers over time. For example, portable electronic devices often include USB Type-C receptacle connectors for various purposes such as charging and/or exchanging data with another electronic device by connecting the USB receptacle connector with a USB plug connector.

Some USB connectors are water resistant. These connectors may include seals that block water from outside the computer enclosure from entering the computer enclosure through the opening left for the connector.

### BRIEF SUMMARY

Aspects of the present application relate to compact, reliable receptable connectors for an electronic device.

Some embodiments relate to a receptacle connector. The receptacle connector may comprise a housing; a shell surrounding a cavity and at least partially embedded in the housing, the shell comprising a mating end extending beyond the housing in a mating direction; and a terminal assembly disposed in the shell, the terminal assembly comprising a plurality of conductive elements, the plurality of conductive elements comprising mating ends disposed in the cavity, and tail ends extending out of the shell.

Optionally, the terminal assembly comprises an assembly housing holding the plurality of conductive elements; the assembly housing comprises one or more grooves; and a rear of the shell comprises one or more portions each protruding into a respective groove of the one or more grooves of the assembly housing.

Optionally, the receptacle connector comprises a board lock partially embedded in the housing and comprising one or more mounting portions extending beyond the housing in a mounting direction different from the mating direction.

Optionally, the mounting direction is perpendicular to the mating direction.

Optionally, the shell comprises a sidewall and a connecting portion; and the connecting portion comprises a first end connected to a rear of the sidewall and a second end connected to the board lock such that the board lock extends next to the sidewall.

Optionally, the board lock comprises a beam elongated in the mating direction and embedded in the housing; and the one or more mounting portions extend from the beam in the mounting direction.

Optionally, the receptacle connector comprises a sealing member disposed on the mating end of the shell.

Optionally, the mating end of the shell comprises a rough portion that has a surface roughness higher than a rest of the mating end of the shell; and the sealing member is disposed on the rough portion of the mating end of the shell.

Optionally, the terminal assembly comprises an assembly housing; a rear of the housing of the receptacle connector extends beyond the assembly housing; the sealing member disposed on the mating end of the shell is a first sealing member; and the receptacle connector comprises a second sealing member disposed in the rear of the housing of the receptacle connector and on a bottom wall of the shell.

Optionally, the second sealing member comprises cured adhesive.

Some embodiments relate to a receptacle connector. The receptacle connector may comprise a terminal assembly comprising an assembly housing and a plurality of conductive elements held by the assembly housing, each of the plurality of conductive elements comprising a mating end, a tail end extending out of the assembly housing, and an intermediate portion between the mating end and the tail end; a shell surrounding at least the mating ends and intermediate portions of the plurality of conductive elements and engaging at least a portion of the assembly housing; and a housing disposed outside the shell and molded over a rear of the shell.

Optionally, the rear of the shell comprises a bottom wall extends out of the housing; and the receptacle connector comprises a sealing member disposed on the bottom wall of the rear of the shell.

Optionally, the bottom wall of the rear of the shell comprises one or more portions protruding toward the terminal assembly; and the sealing member comprises a side conforming to a surface of the bottom wall of the rear of the shell and other sides conforming to inner surfaces of the housing.

Optionally, the receptacle connector comprises a pair of board locks disposed on opposite sides of the shell and partially embedded in the housing.

Optionally, each of the pair of board locks comprises one or more mounting portions extending beyond the housing in a mounting direction.

Optionally, the pair of board locks extend from opposite sides of the shell.

Some embodiments relate to a method of manufacturing a receptacle connector. The method may comprise providing a shell surrounding a cavity and comprising one or more portions protruding into the cavity; providing a terminal assembly comprising an assembly housing and a plurality of conductive elements held by the assembly housing; inserting the terminal assembly into the cavity of the shell; and molding a housing over portions of the shell.

Optionally, molding the housing over portions of the shell comprises molding the housing over portions of a board lock.

Optionally, the method comprises applying an adhesive between a top of the housing and a bottom of the shell; and curing the adhesive to form a seal.

Optionally, the method comprises subsequent to molding the housing, severing a lead frame from the shell and the board lock.

Some embodiments relate to a receptacle connector. The receptacle connector for an electronic device may be configured for connecting with a corresponding plug connector in a mating direction. The receptacle connector may comprise a terminal assembly which may comprise a plurality of conductive elements, and an assembly housing accommodating the conductive elements and molded over the conductive elements to form an integral component; a shell which may have a hollow substantially cylindrical shape and sleeved on at least a portion of an outer side of the terminal assembly; a housing provided on at least a portion of an outer side of the shell; and a first sealing member attached to the shell, wherein the housing may be molded over at least a portion of an outer side of the shell and may form an integral component with the shell. The receptacle connector may further comprise a first board lock and a second board lock provided respectively on opposite sides of the receptacle connector in a width direction perpendicular to the mating direction, wherein, the first board lock and the second board lock are at least partially embedded in the housing and extend beyond the housing in a thickness direction perpendicular to the mating direction of the receptacle connector, and the first board lock and the second board lock are respectively spaced apart from two opposite sidewalls of the shell located in a width direction perpendicular to the mating direction.

Optionally, the first board lock may comprise a cantilever portion extending along the mating direction and a plurality of mounting portions extending from the cantilever portion along the thickness direction, the plurality of mounting portions may comprise a first mounting portion and a second mounting portion spaced apart from each other, at least a portion of each of the first mounting portion and the second mounting portion as well as the cantilever portion are embedded in the housing, and a distal end of the first mounting portion and a distal end of the second mounting portion extend beyond the housing.

Optionally, the first board lock and the second board lock may be mirrored about a plane passing through a vertical central axis of the shell along the thickness direction.

Optionally, the shell may comprise a first sidewall and a second sidewall opposite in the width direction, and the shell may further comprise a first connecting portion which connects the first board lock with the first sidewall between a rear end of the first board lock and a rear end of the first sidewall; and a second connecting portion which connects the second board lock with the second sidewall between a rear end of the second board lock and a rear end of the second sidewall, and the shell is formed integrally with the first board lock and the second board lock.

Optionally, each of the first connecting portion and the second connecting portion may be formed to have a U-shaped shape.

Optionally, the first board lock and the second board lock may be separately formed members from a sidewall of the shell.

Optionally, the shell may comprise one or more stop portions which may be provided near a rear end of the shell and protruding toward an inner side of the shell, and the stop portion may be formed integrally with the shell.

Optionally, the stop portion may comprise a first stop portion, a second stop portion, and a third stop portion, the first stop portion may be provided on a third sidewall of the shell, the second stop portion and the third stop portion may be provided on a fourth sidewall of the shell and spaced apart from each other, the third sidewall is facing the fourth sidewall in the thickness direction, the first stop portion may be formed with a concave portion recessed inward relative to an outer surface of the third sidewall, and the second stop portion and the third stop portion may be formed with a concave portion recessed inward relative to an outer surface of the fourth sidewall.

Optionally, the assembly housing of the terminal assembly may comprise a first receiving portion in cooperation with the first stop portion, a second receiving portion in cooperation with the second stop portion, and a third receiving portion in cooperation with the third stop portion, the first receiving portion may be provided on an outer surface of one side of the assembly housing in the thickness direction, and the second receiving portion and the third receiving portion may be provided on an outer surface of the other side of the assembly housing in the thickness direction.

Optionally, the first stop portion, the second stop portion and the third stop portion may be respectively engaged with the first receiving portion, the second receiving portion, and the third receiving portion in a snap-fit manner.

Optionally, the first stop portion, the second stop portion and the third stop portion may be respectively engaged with the first receiving portion, the second receiving portion, and the third receiving portion in an interference-fit manner.

Optionally, the receptacle connector may comprise a first sealing member, in the mating direction a mating end of the shell extends beyond a mating end of the housing, the first sealing member is attached to an outer sidewall of the mating end of the shell extending beyond the mating end of the housing, and a rear end of the first sealing member is attached to the mating end of the housing.

Optionally, a rough portion may be provided on an outer sidewall of the mating end of the shell extending beyond the mating end of the housing; and a first sealing member may be attached to the rough portion of the shell, and the rough portion comprises a pattern formed by at least one of a diagonal pattern, a grid pattern, or a predetermined symbol pattern.

Optionally, the rough portion may be provided within a width range of 0.5 mm to 1.5 mm from the proximal edge of the shell in the mating direction on the outer sidewall of the shell.

Optionally, the first sealing member may be an elastically deformable member and the first sealing member may be configured to elastically deform when the first sealing member contacts and cooperates with the mounting portion of the electronic device and to form an interference fit with the mounting portion of the electronic device in a direction perpendicular to the mating direction.

Optionally, the first sealing member may be configured to have an annular shape extending circumferentially and continuously around the mating end of the shell, and the first sealing member may be configured to have an attachment surface forming a shape- and position-fit with the mating end of the shell.

Optionally, the first sealing member may be provided with a tapering portion tapering along the mating direction towards the mating end of the first sealing member, and an inclined outer surface of the tapering portion forms an angle of 20 degrees to 40 degrees relative to the surface of the mating end of the first sealing member.

Optionally, in the mating direction, a rear end of the housing may enclose a rear end of the shell, and the rear end of the housing may enclose at least a portion of a rear end of the assembly housing.

Optionally, the receptacle connector may comprise a second sealing member which may be provided on a surface of the rear end of the assembly housing and exposes the conductive elements from the second sealing member, and an outer circumferential surface of the second sealing member is connected with an inner sidewall of at least a portion of the rear end of the housing that encloses at least a portion of the rear end of the assembly housing.

Optionally, the second sealing member may have a thickness in the range of 0.5 mm to 1.5 mm in the mating direction.

Some embodiments relate to a receptacle connector. The receptable connector may include a method of manufacturing a receptacle connector according to an exemplary embodiment of the present application, and the receptacle connector is for connecting with a corresponding plug connector in a mating direction, where the method may comprise: providing a terminal assembly which may comprise a plurality of conductive elements, and an assembly housing accommodating the conductive elements, where the assembly housing is molded over the conductive elements to form an integral component; providing a shell having a substantively cylindrical shape, where the shell is sleeved on at least a portion of an outer side of the terminal assembly; providing a housing, where the housing is provided on at least a portion of an outer side of the shell; applying an adhesive to the shell, where the adhesive is cured to form a first sealing member attached to the shell, wherein the method comprises providing a first board lock and a second board lock on opposite sides of the receptacle connector in a width direction perpendicular to a mating direction, wherein providing the housing comprises molding the housing on at least a portion of an outer side of the shell, the housing is formed such that the first board lock and the second board lock are at least partially embedded in the housing and extend beyond the housing in a thickness direction perpendicular to the mating direction of the receptacle connector, and the first board lock and the second board lock are spaced apart from two opposite sidewalls of the shell located in a width direction perpendicular to the mating direction.

Optionally, the first board lock and the second board lock of the shell may be formed by stamping, stretching and bending.

Optionally, providing the housing may comprise molding the housing over the shell to form an integral component.

Optionally, providing the shell may comprise: providing a shell prefabricated member comprising a body portion and a support frame portion connected to the body portion, where the body portion comprises a hollow cylindrical portion, at least a portion of a mating end of the support frame portion is connected with a rear end of an outer sidewall of the body portion, the body portion is formed integrally with the first board lock and the second board lock, and the support frame portion may be removed before, or after forming the housing by injection molding.

Optionally, the method may further comprise stamping one or more stop portions protruding toward an inner side of the shell at a rear end of the shell.

Optionally, providing the shell may further comprise roughening a portion of an outer surface of the shell near its mating end by laser engraving processing or electrical discharge processing to form a rough portion; or embossing or knurling a portion of the outer surface of the shell near its mating end to form the rough portion.

Optionally, the method may further comprise: providing an adhesive forming tool that matches with the first sealing member in terms of a predetermined size and shape; placing a rough portion of the mating end of the shell to be processed in the adhesive forming tool, and applying an adhesive at the rough portion in a circumferential direction along the shell, wherein the adhesive is applied in the adhesive forming tool by one of the following: time and pressure type dispensing, piston pump dispensing, and screw metering pump dispensing.

Optionally, the method may further comprise applying a second sealing member at a surface of a rear end of the assembly housing and connecting an outer circumferential surface of the second sealing member with an inner sidewall of the housing extending beyond the shell and the rear end of the assembly housing.

These techniques may be used alone or in any suitable combination. The foregoing summaries are provided by way of illustration and are not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a front perspective view of an exemplary receptacle connector, according to some embodiments.

FIG. 2 is a rear perspective view of the receptacle connector of FIG. 1, according to some embodiments.

FIG. 3 is a side view of the receptacle connector of FIG. 1, according to some embodiments.

FIG. 4 is a rear view of the receptacle connector of FIG. 1, according to some embodiments.

FIG. 5 is a partially exploded perspective schematic view of the receptacle connector of FIG. 1, according to some embodiments.

FIG. 6 is a top perspective view of a shell of the receptacle connector of FIG. 1, according to some embodiments.

FIG. 7 is a side view of the shell of FIG. 6, according to some embodiments.

FIG. 8 is a rear view of the shell of FIG. 6, according to some embodiments.

FIG. 9 is a top perspective view of the shell of the receptacle connector of FIG. 6 before over molding, according to some alternative embodiments.

FIG. 10 is a perspective view of terminal assembly of the receptacle connector of FIG. 1, according to some embodiments.

FIG. 11 is a rear view of the terminal assembly of FIG. 10, according to some embodiments.

FIG. 12 is a section view of the receptacle connector of FIG. 1 along a line marked “12-12” in FIG. 10, according to some embodiments.

### DETAILED DESCRIPTION

The inventors have recognized and appreciated techniques for making compact, reliable receptacle connectors. A receptacle connector inside a chassis of an electronic device may be configured to receive a mating component such as a plug connector to enable the electronic device to connect with other devices. Connectors according to conventional designs may have a number of components, including multiple shells, which are prone to movements relative to each other, such as when a force is applied to insert or remove a mating component from the connector. Such a force may cause various issues such as over-insertion and therefore poor or intermittent electrical contact or may cause terminal assembly dislocation.

Techniques described herein enable more compact receptacle connectors while maintaining/improving robustness. Such techniques are illustrated herein as applied to a USB Type-C right-angle receptacle connector. According to aspects of the present disclosure, a receptacle connector may include terminals held by an assembly housing. A shell may surround mating ends of the terminals and engage with the assembly housing. A housing may be disposed outside the shell and partially enclose a rear of the shell. A board lock may be also partially embedded in the housing. Such a configuration enables the connector to have a single shell and reduce the risk of relevant movements between the shell/board lock and the housing when, for example, a mating component is inserted into or removed from the connector. The connector may comprise a front seal disposed around a portion of the shell that extends beyond the housing, and a rear seal disposed between a top of the housing and a bottom of the shell. The seals may be made from an adhesive (e.g., UV glue, silicone, epoxy glue, or underfill). An adhesive may provide flexibility in locating the seals, as the adhesive may be applied in a liquid or viscous state and cured in place. Such a configuration can block ingress of environmental contaminants from both the front and the rear.

According to aspects of the present disclosure, risk of relative movement between the housing and the shell in the mating direction is reduced, which may also improve the sealing stability of the receptacle connector. For example, when the receptacle connector has been inserted/withdrawn several times, any relative displacement between components of the receptacle connector may be so small as to be negligible or immeasurable with conventional tools. The receptacle connector may be structurally more compact and stable than conventional designs, which can block ingress of environmental contaminants more effectively and lead to a longer service life.

Some of all of the foregoing techniques may be used to provide a compact connector. In some examples, the connector may occupy less space in an electronic system than a connector made according to conventional techniques to meet a standard, such as USB-C. Instead of or in addition to techniques as described above, the connector may have a limited number of terminals, such as 6 terminals. The terminals may be positioned, for example, to mate with terminals of a plug connector compliant with USB-C standards that are used for power delivery.

Next, exemplary embodiments of the receptacle connector according to one aspect of the present application will be described in detail with reference to the accompanying drawings.

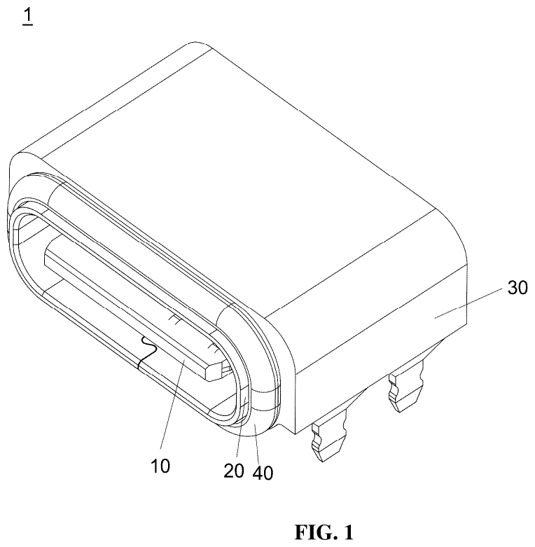

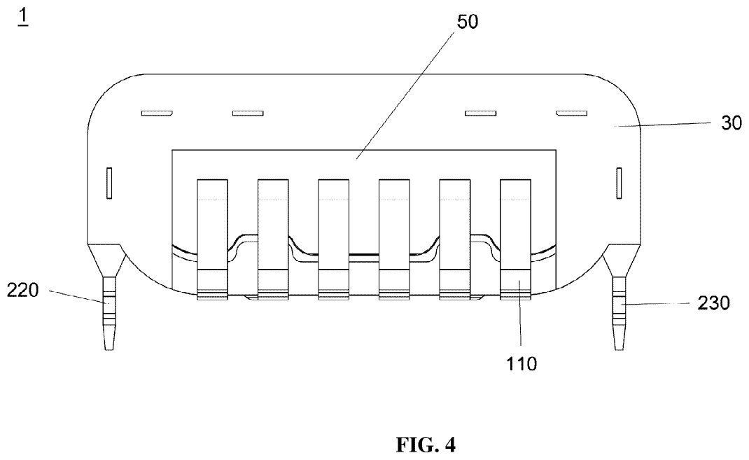

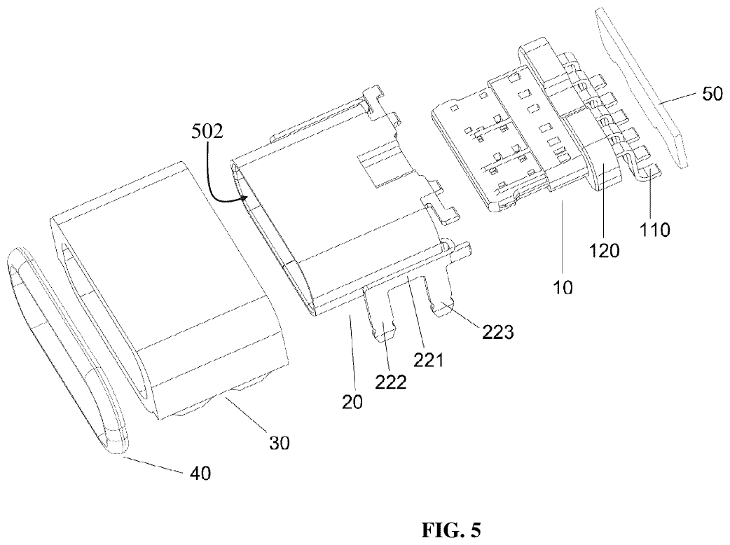

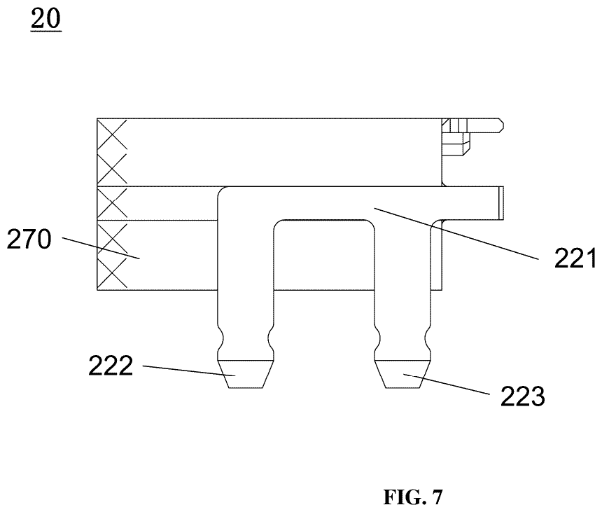

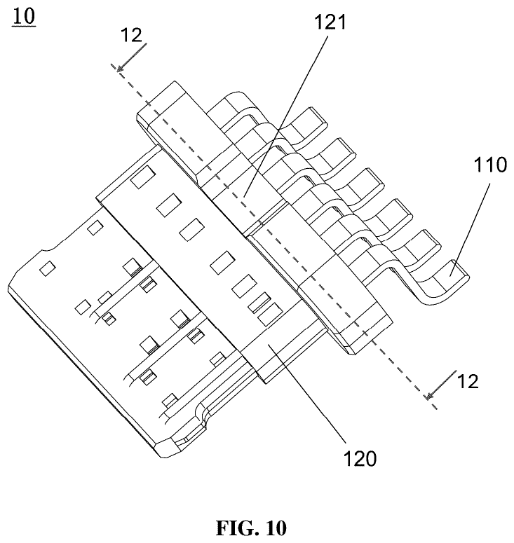

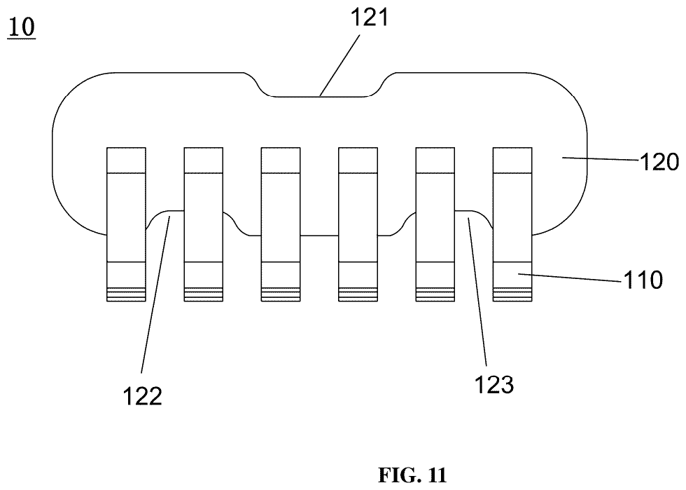

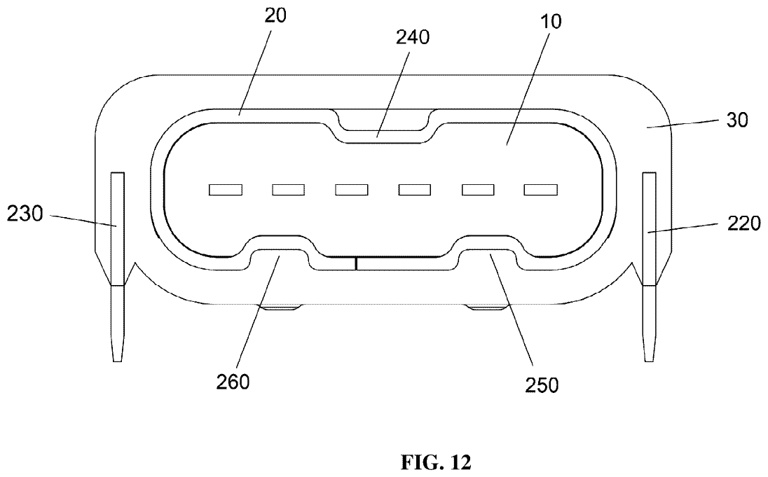

As shown in FIGS. 1-12, the receptacle connector 1 is for connecting with a corresponding plug connector in a mating direction X, to establish an electrical and/or signal connection to an external electronic device. The receptacle connector 1 may comprise a terminal assembly 10, a shell 20, a housing 30, and a first sealing member 40 attached to the shell 20. The terminal assembly 10 may comprise a plurality of conductive elements 110 and an assembly housing 120 accommodating the conductive elements. The assembly housing 120 of the terminal assembly 10 may be molded over the conductive elements 110 to form an integral component, as shown in FIG. 10 and FIG. 11. In some exemplary embodiments, the assembly housing 120 may be made of an insulative material, such as plastic or nylon. Examples of suitable materials include, but are not limited to, liquid crystal polymer (LCP), polyphenylene sulfide (PPS), high temperature nylon or polyphenylenoxide (PPO) or polypropylene (PP). Other suitable materials may be employed, as aspects of the present disclosure are not limited in this regard. The shell 20 may have a hollow, substantially cylindrical shape and may be sleeved on at least a portion of an outer side of the terminal assembly 10. The shell 20 may be made of a metallic material. The housing 30 may be provided on at least a portion of an outer side of the shell 20.

A first board lock 220 and a second board lock 230 may be provided respectively on opposite sides of the receptacle connector 1 in a width direction Y perpendicular to the mating direction X. As shown, the first board lock 220 and the second board lock 230 are respectively spaced apart from two opposite sidewalls of the shell 20 located in a width direction Y perpendicular to the mating direction X. The housing 30 is molded over at least a portion of the outer side of the shell 20, and forms an integral component with the shell 20. As shown in FIG. 1, the first board lock 220 and the second board lock 230 are at least partially embedded in the housing 30 and extend beyond the housing 30 in a thickness direction Z perpendicular to the mating direction X of the receptacle connector 1, for example, exposed from the housing 30.

When the receptacle connector according to an exemplary embodiment of the present application is mated with a corresponding plug connector, a relative movement between the shell 20 and the housing 30 along the mating direction X is prevented, since the first board lock and the second board lock of the shell 20 are at least partially embedded in the housing 30 and extend at least partially beyond the housing 30. Relative movement between the various components provided in the receptacle connector 1 will also be prevented. For example, relative movement between the first sealing member 40 provided on the shell 20 and the shell 20 and with the housing 30 will be prevented so that gaps will not appear between the various components of the receptacle connector. For example, even if the receptacle connector has been inserted/withdrawn several times, there is no relative displacements between various components of the receptacle connector, for example, a delaminated phenomenon or a phenomenon where the sealing member falls off will not occur, such that the receptacle connector is structurally more compact and stable, which significantly improves the waterproof performance of the receptacle connector.

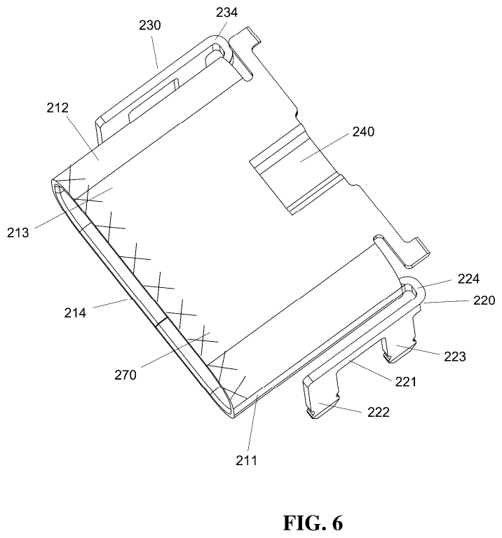

The first board lock 220 is provided with a cantilever portion 221 substantially extending along the mating direction X and a plurality of mounting portions extending from the cantilever portion 221 along the thickness direction Z. As shown in FIGS. 6-8, the first board lock 220 is provided with a first mounting portion 222 and a second mounting portion 223 spaced apart from each other. At least a portion of each of the first mounting portion 222 and the second mounting portion 223 as well as the cantilever portion 221 are embedded in the housing 30, and a distal end of the first mounting portion 222 and a distal end of the second mounting portion 223 extend beyond the housing 30.

According to an exemplary embodiment of the present application, a snap engagement portion may be provided on the distal end of the first mounting portion 222 and the distal end of the second mounting portion 223, respectively. In the case where the receptacle connector 1 is connected to a component to be applied, such as a printed circuit board, the snap engagement portions of the first mounting portion 222 and the second mounting portion 223 are mated with a corresponding engagement portion of the printed circuit board in the thickness direction Z. Optionally, the distal end of the first mounting portion 222 and the distal end of the second mounting portion 223 may also be connected to the component to be applied by soldering. It should be understood that the first mounting portion and the second mounting portion may also be connected to the component to be applied by any other suitable connections.

As shown in in FIGS. 6-8, the first board lock 220 and the second board lock 230 are mirrored about a plane passing through a vertical central axis of the shell 20 along the thickness direction Z. This symmetrical provision may allow a more uniform force to be applied to the receptacle connector 1 when the receptacle connector 1 is withdrawn and inserted, thus enabling a more structurally stable receptacle connector.

As shown in FIGS. 6-8, the shell 20 comprises a first sidewall 211 and a second sidewall 212 opposite in the width direction Y and a third sidewall 213 and a fourth sidewall 214 opposite in the thickness direction Z, according to an exemplary embodiment of the present application. The shell 20 may also include a first connecting portion 224 and a second connecting portion 234, as illustrated in FIG. 6. The first connecting portion 224 is provided between a rear end of the first board lock 220 and a rear end of the first sidewall 211 and connects the first board lock 220 with the first sidewall 211. The second connecting portion 234 is provided between a rear end of the second board lock 230 and a rear end of the second sidewall 212 and connects the second board lock 230 with the second sidewall 212. The shell 20 is formed integrally with the first board lock 220 and the second board lock 230. For example, the shell 20 and the first and second board locks 220, 230 may be formed integrally by stamping a sheet of metal and wrapping, folding, and/or bending the stamped sheet.

In some embodiments, the first board lock 220, the second board lock 230, the first connecting portion 224, and the second connecting portion 234 may be made of the same material as the shell, e.g., a metallic material.

In some embodiments, each of the first connecting portion 224 and the second connecting portion 234 is formed to have a U-shaped shape. It should be understood that the first connecting portion 224 and the second connecting portion 234 may be formed to have any other suitable shape, such as a rectilinear shape or a semi-circular shape.

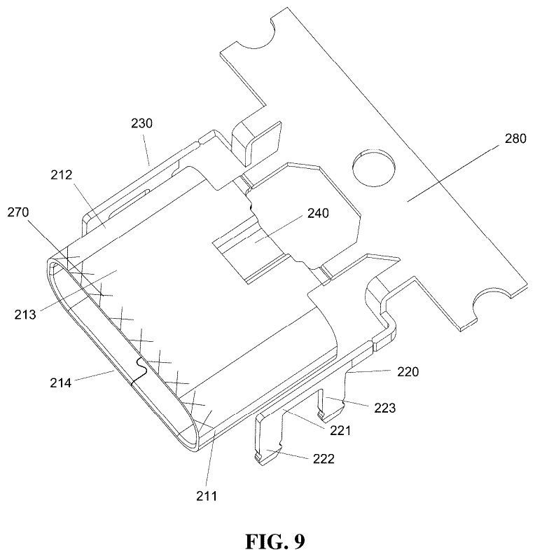

According to another exemplary embodiment of the present application, the first board lock 220 and the second board lock 230 of the shell 20 may be separately formed members independent of the sidewalls of the shell 20, as shown in FIG. 9.

As shown in FIG. 6, one or more stop portions may be provided near the rear end of the shell 20, the stop portions protruding toward the inner side of the shell 20. The stop portions are formed integrally with the shell 20. For example, the stop portions are part of the shell 20, and no additional attachment components for attaching the shell 20 to the terminal assembly 10 are required, which reduces the number of components of the receptacle connector, and simplifies the manufacturing process, enabling a compact structure while also improving the durability of the receptacle connector. Thus, the contact stability and the connection reliability between the plug connector and the receptacle connector are improved.

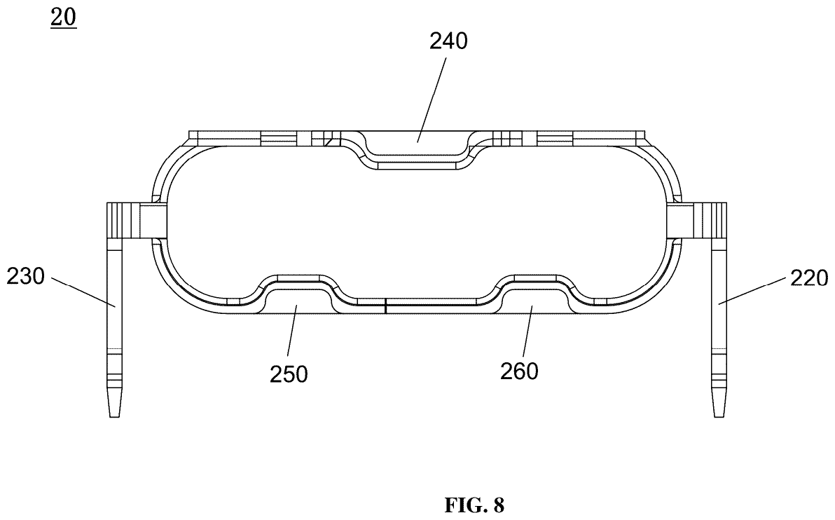

As shown in FIG. 8, the shell 20 may be provided with three stop portions, wherein the first stop portion 240 is provided on the third sidewall 213 of the shell 20, and the second stop portion 250 and the third stop portion 260 are provided on the fourth sidewall 214 of the shell 20 and spaced apart from each other. The first stop portion 240 may be formed with a concave portion recessed inward relative to an outer surface of the third sidewall 213, and the second stop portion 250 and the third stop portion 260 may be formed with a concave portion recessed inward relative to an outer surface of the fourth sidewall 214.

As shown in FIG. 10 and FIG. 11, the assembly housing 120 of the terminal assembly 10 may be provided with a first receiving portion 121 in cooperation with the first stop portion 240, a second receiving portion 122 in cooperation with the second stop portion 250, and a third receiving portion 123 in cooperation with the third stop portion 260. The first receiving portion 121 is provided on one side of the assembly housing 120 in the thickness direction Z, and the second receiving portion 122 and the third receiving portion 123 are provided on the other side of the assembly housing 120 in the thickness direction Z.

In some exemplary embodiments, the first stop portion 240, the second stop portion 250 and the third stop portion 260 may be respectively engaged with the first receiving portion 121, the second receiving portion 122, and the third receiving portion 123 in a snap-fit manner or an interference-fit manner.

As shown in FIG. 1, in the mating direction X, the mating end of the shell 20 extends beyond the mating end of the housing. The first sealing member 40 is provided along a circumferential direction of the shell 20 on an outer sidewall of the shell 20 extending beyond the mating end of the housing 30. The first sealing member 40 seals the engagement portion between the shell 20 and the housing 30 in a circumferential direction. In addition, when the receptacle connector is connected with a mounting portion of a corresponding electronic device, the first sealing member 40 further forms a seal between the shell and the mounting portion of the electronic device, effectively preventing water or dust entering from the socket of the USB Type-C receptacle connector from entering the interior of the electronic device, avoiding a short circuit inside the electronic device, and improving safety performance.

In some exemplary embodiments, as shown in FIGS. 6-9, a rough portion 270 is provided on an outer sidewall of the mating end of the shell 20 extending beyond the mating end of the housing 30. The first sealing member 40 is attached to the rough portion 270 of the shell 20, and the rough portion 270 comprises a pattern formed by at least one of a diagonal pattern, a grid pattern, or a predetermined symbol pattern.

According to an exemplary embodiment of the present application, the first sealing member 40 is attached to the rough portion 270. The rough portion 270 has a coefficient of friction greater than other portions of the outer sidewall of the shell. Therefore, by the provision of the rough portion, an adhesion force between the first sealing member and the rough portion of the shell is significantly improved, which allows a much tighter attachment between the first sealing member 40 and the shell 20, and effectively avoids the phenomenon where the first scaling member 40 shifts relative to the shell thus generating a gap or even falling off. Therefore, a seal can be generated between the receptacle connector and the mounting portion of the electronic device when mounting the receptacle connector 1 to the mounting portion of the electronic device to effectively prevent water vapor/dust from entering inside the electronic device.

In some exemplary embodiments according to the present application, a surface roughness of the rough portion 270 of the shell 20 may be in the range of EDM 8-12.

In some exemplary embodiments, the rough portion 270 is provided within a width range of 0.5 mm to 1.5 mm from the proximal edge of the shell 20 in the mating direction X on the outer sidewall of the shell 30.

According to an exemplary embodiment of the present application, the first sealing member 40 may be an elastically deformable member and the first sealing member 40 may be configured to elastically deform when the first sealing member 40 contacts and cooperates with the mounting portion of the electronic device and to form an interference fit with the mounting portion of the electronic device in a direction perpendicular to the mating direction X. In one example, the first sealing member 40 may be made of ultraviolet light-curable adhesive (UV adhesive), silicone, or epoxy resin adhesive. Ultraviolet light-curable adhesive is rapidly cured into an elastic adhesive film under UV light irradiation, and is characterized by high adhesive strength, vibration resistance, high temperature resistance, and good durability, etc.

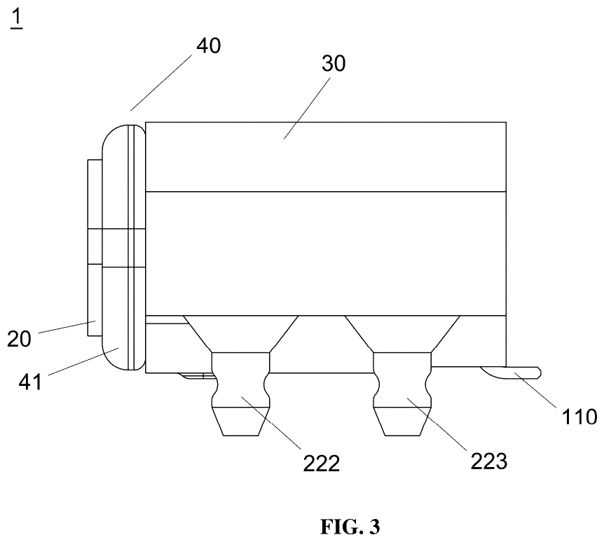

In some exemplary embodiments, as shown in FIG. 3, the first sealing member 40 is configured to have an annular shape extending in circumferential direction continuously around the mating end of the shell 20. The sealing member 40 is further configured to have an attachment surface forming a positive fit with the mating end of the shell 20. The first sealing member 40 may be provided with a tapering portion 41 tapering along the mating direction X towards the mating end thereof, and an inclined outer surface of the tapering portion 41 forms an angle of 20 degrees to 40 degrees relative to the surface of the mating end of the first sealing member 40.

In some optional exemplary embodiments, an inclined outer surface of the tapering portion 41 forms an angle of 30 degrees relative to the surface of the mating end of the first sealing member 40.

It should be understood that the term “a shape- and position-fit” used in the present application may refer to a relationship in which two mating components are abutting and tightly fit with each other in terms of the shape and the position.

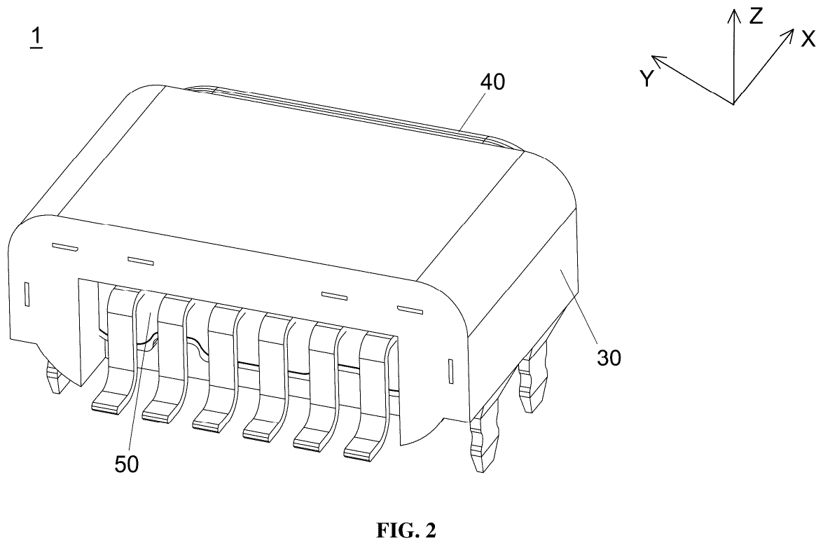

As shown in FIG. 2, in the mating direction X, a rear end of the housing 30 may enclose a rear end of the shell 20, and the rear end of the housing 30 may further enclose at least a portion of a rear end of the assembly housing 120. A second sealing member 50 is provided on a surface of the rear end of the assembly housing 120, wherein the conductive elements 110 are exposed from the second sealing member 50. In some exemplary embodiments, the second sealing member 50 may be formed of rubber or resin. An outer circumferential surface of the second sealing member 50 is connected with an inner sidewall of the outer end of the housing that encloses at least a portion of the rear end of the assembly housing 120, thereby sealing the rear end of the receptacle connector 1. The provision of the second sealing member 50 effectively avoids water vapor or dust entering from the rear end of the receptacle connector from entering the interior of the receptacle connector even the electronic device.

As shown in FIG. 2, the plurality of conductive elements 110 extend in the mating direction. In some examples, the receptacle connector 1 comprises six conductive elements. It should be understood that the number, the size, the location and the arrangement mode of the conductive elements are not limited to the specific embodiment shown can be adjusted as actually needed.

In some exemplary embodiments, the second sealing member 50 has a thickness in the range of 0.5 mm to 1.5 mm in the mating direction X. Preferably, the second sealing member 50 has a thickness of 1.0 mm in the mating direction X.

According to an exemplary embodiment of the present application, the provision of the first scaling member 40 and the second sealing member 50 achieves double sealing of the receptacle connector and improves the waterproof performance. In addition, by mating the shell with the housing, the receptacle connector is structurally compact, which further improves the stability of the waterproof performance of the receptacle connector.

Another aspect of the present application provides a method of manufacturing a receptacle connector according to an exemplary embodiment of the present application. The method of manufacturing a receptacle connector according to an exemplary embodiment of the present application may comprise: providing a terminal assembly 10 which may comprise a plurality of conductive elements 110, and an assembly housing 120 accommodating the conductive elements 110, where the assembly housing 120 is molded over the conductive elements 110 to form an integral component; providing a shell 20 having a substantively cylindrical shape, where the shell 20 is sleeved on at least a portion of an outer side of the terminal assembly 10; providing a housing 30, where the housing 30 is provided on at least a portion of an outer side of the shell 20; applying an adhesive to the shell 20, where the adhesive is cured to form a first sealing member 40 attached to the shell 20.

Providing the shell 20 further comprises providing a first board lock 220 and a second board lock 230 on opposite sides of the receptacle connector 1 in a width direction Y perpendicular to the mating direction X. Providing the housing 30 comprises: molding the housing 30 on at least a portion of an outer side of the shell 20, and forming the housing 30 such that the first board lock 220 and the second board lock 230 are at least partially embedded in the housing 30 and extend beyond the housing 30 in a thickness direction Z perpendicular to the mating direction X of the receptacle connector 1, and the first board lock 220 and the second board lock 230 are spaced apart from two opposite sidewalls of the shell 20 located in a width direction Y perpendicular to the mating direction X.

In some optional embodiments, the first board lock 220 and the second board lock 230 of the shell 20 may be formed as an integral component by stamping, stretching and/or bending. The overall strength of the shell is significantly improved by the integral component. However, it should be understood that the first board lock and the second board lock may also be formed separately.

In some optional embodiments, providing the housing 30 may further comprise: forming the housing 30 by insert injection molding over the shell 20. It should be understood that the housing 30 may also be formed as an integral component with the shell 20 by over-molding.

In some optional embodiments, as schematically shown in FIG. 9, providing the shell 20 may further comprise: providing a shell 20 prefabricated member comprising a body portion and a support frame portion 280 connected to the body portion, where the body portion comprises a hollow cylindrical portion, at least a portion of a mating end of the support frame portion 280 is connected with a rear end of an outer sidewall of the body portion, the body portion is formed integrally with the first board lock 220 and the second board lock 230, and the support frame portion 280 is removed before, or after the housing 30 is formed over the shell 20 by injection molding to form an integral component.

In some optional embodiments, the method may further comprise stamping one or more stop portions protruding toward an inner side of the shell 20 at a rear end of the shell 20.

In some optional embodiments, providing the shell 20 further comprises: roughening a portion of an outer surface of the shell 20 near its mating end by laser engraving processing or electrical discharge processing to form a rough portion 270; or embossing or knurling a portion of the outer surface of the shell 20 near its mating end to form the rough portion 270.

It should be understood that other processing methods can also be used to increase the surface roughness of corresponding portions of the outer surface of the shell 20. For example, the surface of the shell 20 can be processed by using tools such as grinding wheels, cutting tools, etc., to obtain the desired roughness.

In some optional embodiments, the method further comprises: providing an adhesive forming tool that matches with the first sealing member 40 in terms of a predetermined size and shape; placing a rough portion 270 of the mating end of the shell 20 to be processed in the adhesive forming tool, and applying an adhesive at the rough portion 270 in a circumferential direction along the shell 20, wherein the adhesive is applied in the adhesive forming tool by one of the following: time and pressure type dispensing, piston pump dispensing, and screw metering pump dispensing.

In some optional embodiments, the method further comprises applying a second scaling member 50 at a surface of a rear end of the assembly housing 120 and connecting an outer circumferential surface of the second sealing member 50 with an inner sidewall of the housing 30 extending beyond the shell 20 and the rear end of the assembly housing 120.

The receptacle connector according to an exemplary embodiment of the present application may achieve a high waterproof rating, for example up to IPX4, IPX5, IPX6, IPX7, IPX8.

Various aspects are described in this disclosure, which include, but are not limited to, the following aspects:
1. A receptacle connector (e.g., 1) for an electronic device, for connecting with a corresponding plug connector in a mating direction (e.g., X), comprising: a terminal assembly (e.g., 10) comprising a plurality of conductive elements (e.g., 110) and an assembly housing (e.g., 120) for holding the conductive elements (e.g., 110); a shell (e.g., 20) having a hollow cylindrical shape and sleeved on at least a portion of an outer side of the terminal assembly (e.g., 10); a housing (e.g., 30) provided on at least a portion of an outer side of the shell (e.g., 20); and a first sealing member (e.g., 40) attached to the shell (e.g., 20), wherein the housing (e.g., 30) is molded over at least a portion of the outer side of the shell (e.g., 20), the housing (e.g., 30) is molded over the shell (e.g., 20) to form an integral component, and the receptacle connector (e.g., 1) further comprises a first board lock (e.g., 220) and a second board lock (e.g., 230) provided respectively on opposite sides of the receptacle connector (e.g., 1) in a width direction (e.g., Y) perpendicular to the mating direction (e.g., X), wherein the first board lock (e.g., 220) and the second board lock (e.g., 230) are at least partially embedded in the housing (e.g., 30) and extend beyond the housing (e.g., 30) in a thickness direction (e.g., Z) perpendicular to the mating direction (e.g., X) of the receptacle connector (e.g., 1), and the first board lock (e.g., 220) and the second board lock (e.g., 230) are respectively spaced apart from two opposite sidewalls of the shell (e.g., 20) located in the width direction (e.g., Y) perpendicular to the mating direction (e.g., X).
2. The receptacle connector according to aspect 1 or any other aspect, wherein the first board lock (e.g., 220) comprises a cantilever portion (e.g., 221) extending along the mating direction (e.g., X) and a plurality of mounting portions extending from the cantilever portion (e.g., 221) along the thickness direction (e.g., Z), the plurality of mounting portions comprises a first mounting portion (e.g., 222) and a second mounting portion (e.g., 223) spaced apart from each other, at least a portion of each of the first mounting portion (e.g., 222) and the second mounting portion (e.g., 223) as well as the cantilever portion (e.g., 221) are embedded in the housing (e.g., 30), and a distal end of the first mounting portion (e.g., 222) and a distal end of the second mounting portion (e.g., 223) both extend beyond the housing (e.g., 30).
3. The receptacle connector according to aspect 2 or any other aspect, wherein the first board lock (e.g., 220) and the second board lock (e.g., 230) are mirrored about a plane passing through a vertical central axis of the shell (e.g., 20) along the thickness direction (e.g., Z).
4. The receptacle connector according to any one of aspects 1 to 3 or any other aspect, wherein the shell (e.g., 20) comprises a first sidewall (e.g., 211) and a second sidewall (e.g., 212) opposite in the width direction (e.g., Y), and the shell (e.g., 20) further comprises a first connecting portion (e.g., 224) which connects the first board lock (e.g., 220) with the first sidewall (e.g., 211) between a rear end of the first board lock (e.g., 220) and a rear end of the first sidewall (e.g., 211); and a second connecting portion (e.g., 234) which connects the second board lock (e.g., 230) with the second sidewall (e.g., 212) between a rear end of the second board lock (e.g., 230) and a rear end of the second sidewall (e.g., 212), and the shell (e.g., 20) is formed integrally with the first board lock (e.g., 220) and the second board lock (e.g., 230).
5. The receptacle connector according to aspect 4 or any other aspect, wherein each of the first connecting portion (e.g., 224) and the second connecting portion (e.g., 234) is formed to have a U-shaped shape.
6. The receptacle connector according to any one of aspects 1 to 3 or any other aspect, wherein the first board lock (e.g., 220) and the second board lock (e.g., 230) are separately formed members from the sidewalls of the shell (e.g., 20).
7. The receptacle connector according to any one of aspects 1 to 3 or any other aspect, wherein the shell (e.g., 20) comprises one or more stop portions provided near rear ends of the shell (e.g., 20) and protruding toward an inner side of the shell (e.g., 20), and the stop portions are formed integrally with the shell (e.g., 20).
8. The receptacle connector according to aspect 7 or any other aspect, wherein the stop portions comprises a first stop portion (e.g., 240), a second stop portion (e.g., 250), and a third stop portion (e.g., 260), the first stop portion (e.g., 240) is provided on a third sidewall (e.g., 213) of the shell (e.g., 20), the second stop portion (e.g., 250) and the third stop portion (e.g., 260) are provided on a fourth sidewall (e.g., 214) of the shell (e.g., 20) and are spaced apart from each other, the third sidewall (e.g., 213) is opposite to the fourth sidewall (e.g., 214) in the thickness direction (e.g., Z), the first stop portion (e.g., 240) is formed with a concave portion recessed inward relative to an outer surface of the third sidewall (e.g., 213), and the second stop portion (e.g., 250) and the third stop portion (e.g., 260) are formed with a concave portion recessed inward relative to an outer surface of the fourth sidewall (e.g., 214).
9. The receptacle connector according to aspect 8 or any other aspect, wherein the assembly housing (e.g., 120) of the terminal assembly (e.g., 10) comprises a first receiving portion (e.g., 121) in cooperation with the first stop portion (e.g., 240), a second receiving portion (e.g., 122) in cooperation with the second stop portion (e.g., 250), and a third receiving portion (e.g., 123) in cooperation with the third stop portion (e.g., 260), the first receiving portion (e.g., 121) is provided on an outer surface of one side of the assembly housing (e.g., 120) in the thickness direction (e.g., Z), and the second receiving portion (e.g., 122) and the third receiving portion (e.g., 123) are provided on an outer surface of the other side of the assembly housing (e.g., 120) in the thickness direction (e.g., Z).
10. The receptacle connector according to aspect 9 or any other aspect, wherein the first stop portion (e.g., 240) is engaged with the first receiving portion (e.g., 121) in a snap-fit manner, the second stop portion (e.g., 250) is engaged with the second receiving portion (e.g., 122) in a snap-fit manner, and the third stop portion (e.g., 260) is engaged with the third receiving portion (e.g., 123) in a snap-fit manner.
11. The receptacle connector according to aspect 9 or any other aspect, wherein the first stop portion (e.g., 240) is engaged with the first receiving portion (e.g., 121) in an interference-fit manner, the second stop portion (e.g., 250) is engaged with the second receiving portion (e.g., 122) in an interference-fit manner, and the third stop portion (e.g., 260) is engaged with the third receiving portion (e.g., 123) in an interference-fit manner.
12. The receptacle connector according to any one of aspects 1 to 3 or any other aspect, wherein the receptacle connector (e.g., 1) comprises a first sealing member (e.g., 40), in view of the mating direction (e.g., X), a mating end of the shell (e.g., 20) extends beyond a mating end of the housing (e.g., 30), the first sealing member (e.g., 40) is attached to an outer sidewall of the mating end of the shell (e.g., 20) extending beyond the mating end of the housing (e.g., 30), and a rear end of the first sealing member (e.g., 40) is attached to the mating end of the housing (e.g., 30).
13. The receptacle connector according to aspect 12 or any other aspect, wherein a rough portion (e.g., 270) is provided on the outer sidewall of the mating end of the shell (e.g., 20) extending beyond the mating end of the housing (e.g., 30), the first sealing member (e.g., 40) is attached to the rough portion (e.g., 270) of the shell (e.g., 20), and the rough portion (e.g., 270) comprises a pattern formed by at least one of a diagonal pattern, a grid pattern, or a predetermined symbol pattern.
14. The receptacle connector according to aspect 13 or any other aspect, wherein the rough portion (e.g., 270) is provided within a width range of 0.5 mm to 1.5 mm from a proximal edge of the shell (e.g., 20) in the mating direction (e.g., X) on the outer sidewall of the shell (e.g., 20).
15. The receptacle connector according to aspect 14 or any other aspect, wherein the first sealing member (e.g., 40) is an elastically deformable member and the first sealing member (e.g., 40) is configured to elastically deform when the first sealing member (e.g., 40) contacts and cooperates with a mounting portion of the electronic device and to form an interference fit with the mounting portion of the electronic device in a direction perpendicular to the mating direction (e.g., X).
16. The receptacle connector according to aspect 14 or any other aspect, wherein the first sealing member (e.g., 40) is configured to have an annular shape extending circumferentially and continuously around the mating end of the shell (e.g., 20), and the first sealing member (e.g., 40) is configured to have an attachment surface forming a positive fit with the mating end of the shell (e.g., 20).
17. The receptacle connector according to aspect 16 or any other aspect, wherein the first sealing member (e.g., 40) is provided with a tapering portion (e.g., 41) tapering along the mating direction (e.g., X) towards the mating end of the first sealing member (e.g., 40), and an inclined outer surface of the tapering portion (e.g., 41) forms an angle of 20 degrees to 40 degrees relative to the mating end surface of the first sealing member (e.g., 40).
18. The receptacle connector according to any one of aspects 1 to 3 or any other aspect, wherein in view of the mating direction (e.g., X), a rear end of the housing (e.g., 30) encloses a rear end of the shell (e.g., 20), and the rear end of the housing (e.g., 30) encloses at least a portion of a rear end of the assembly housing (e.g., 120).
19. The receptacle connector according to aspect 18 or any other aspect, wherein the receptacle connector (e.g., 1) comprises a second sealing member (e.g., 50) provided on the rear end surface of the assembly housing (e.g., 120) and exposing the conductive elements from the second sealing member, and an outer circumferential surface of the second sealing member (e.g., 50) is connected with at least a portion of the inner sidewall of the rear end of the housing (e.g., 30) that encloses the rear end of the assembly housing (e.g., 120).
20. The receptacle connector according to aspect 19 or any other aspect, wherein the second sealing member (e.g., 50) has a thickness in the range of 0.5 mm to 1.5 mm in the mating direction (e.g., X).
21. A receptacle connector comprising: a housing (e.g., 30); a shell (e.g., 20) surrounding a cavity (e.g., 502) and at least partially embedded in the housing, the shell comprising a mating end extending beyond the housing in a mating direction (e.g., X); and a terminal assembly (e.g., 10) disposed in the shell, the terminal assembly comprising a plurality of conductive elements (e.g., 110), the plurality of conductive elements comprising mating ends disposed in the cavity, and tail ends extending out of the shell.
22. The receptacle connector of aspect 21 or any other aspect, wherein the terminal assembly comprises an assembly housing (e.g., 120) holding the plurality of conductive elements; the assembly housing comprises one or more grooves (e.g., 121); and a rear of the shell comprises one or more portions (e.g., 240) each protruding into a respective groove of the one or more grooves of the assembly housing.
23. The receptacle connector of aspect 21 or any other aspect, comprising a board lock partially embedded in the housing and comprising one or more mounting portions extending beyond the housing in a mounting direction different from the mating direction.
24. The receptacle connector of aspect 23 or any other aspect, wherein the mounting direction is perpendicular to the mating direction.
25. The receptacle connector of aspect 3 or any other aspect, wherein the shell comprises a sidewall (e.g., 211) and a connecting portion (e.g., 224); and the connecting portion comprises a first end connected to a rear of the sidewall and a second end connected to the board lock (e.g., 220) such that the board lock extends next to the sidewall.
26. The receptacle connector of aspect 24 or any other aspect, wherein the board lock comprises a beam (e.g., 221) elongated in the mating direction and embedded in the housing; and the one or more mounting portions (e.g., 222, 223) extend from the beam in the mounting direction.
27. The receptacle connector of aspect 21 or any other aspect, comprising a sealing member (e.g., 40) disposed on the mating end of the shell.
28. The receptacle connector of aspect 27 or any other aspect, wherein the mating end of the shell comprises a rough portion that has a surface roughness higher than a rest of the mating end of the shell; and the sealing member is disposed on the rough portion of the mating end of the shell.
29. The receptacle connector of aspect 28 or any other aspect, wherein the terminal assembly comprises an assembly housing; a rear of the housing of the receptacle connector extends beyond the assembly housing; the sealing member disposed on the mating end of the shell is a first sealing member; and the receptacle connector comprises a second sealing member (e.g., 50) disposed in the rear of the housing of the receptacle connector and on a bottom wall of the shell.
30. The receptacle connector of aspect 29 or any other aspect, wherein the second sealing member comprises cured adhesive.
31. A receptacle connector comprising a terminal assembly comprising an assembly housing and a plurality of conductive elements held by the assembly housing, each of the plurality of conductive elements comprising a mating end, a tail end extending out of the assembly housing, and an intermediate portion between the mating end and the tail end; a shell surrounding at least the mating ends and intermediate portions of the plurality of conductive elements and engaging at least a portion of the assembly housing; and a housing disposed outside the shell and molded over a rear of the shell.
32. The receptacle connector of aspect 31 or any other aspect, wherein the rear of the shell (e.g., 20) comprises a bottom wall extends out of the housing; and the receptacle connector comprises a sealing member (e.g., 50) disposed on the bottom wall of the rear of the shell.
33. The receptacle connector of aspect 32 or any other aspect, wherein the bottom wall of the rear of the shell comprises one or more portions (e.g., 250, 260) protruding toward the terminal assembly; and the sealing member comprises a side conforming to a surface of the bottom wall of the rear of the shell and other sides conforming to inner surfaces of the housing.
34. The receptacle connector of aspect 33 or any other aspect, comprising a pair of board locks disposed on opposite sides of the shell and partially embedded in the housing.
35. The receptacle connector of aspect 34 or any other aspect, wherein each of the pair of board locks comprises one or more mounting portions extending beyond the housing in a mounting direction.
36. The receptacle connector of aspect 35 or any other aspect, wherein the pair of board locks extend from opposite sides of the shell.
37. A method of manufacturing a receptacle connector, the method comprising providing a shell (e.g., 20) surrounding a cavity (e.g., 502) and comprising one or more portions protruding into the cavity; providing a terminal assembly (e.g., 10) comprising an assembly housing and a plurality of conductive elements held by the assembly housing; inserting the terminal assembly into the cavity of the shell; and molding a housing (e.g., 30) over portions of the shell.
38. The method of aspect 37 or any other aspect, wherein molding the housing over portions of the shell comprises molding the housing over portions of a board lock.
39. The method of aspect 37 or any other aspect, comprising applying an adhesive between a top of the housing and a bottom of the shell; and curing the adhesive to form a seal (e.g., 50).
40. The method of aspect 38 or any other aspect, comprising subsequent to molding the housing, severing a lead frame (e.g., 280) from the shell and the board lock.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to right angle connectors. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like are shown based on the accompanying drawings, for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A receptacle connector comprising:
a housing;
a shell surrounding a cavity and at least partially embedded in the housing, the shell comprising a mating end extending beyond the housing in a mating direction; and
a terminal assembly disposed in the shell, the terminal assembly comprising a plurality of conductive elements, the plurality of conductive elements comprising mating ends disposed in the cavity, and tail ends extending out of the shell.

2. The receptacle connector of claim 1, wherein:
the terminal assembly comprises an assembly housing holding the plurality of conductive elements;
the assembly housing comprises one or more grooves; and
a rear of the shell comprises one or more portions each protruding into a respective groove of the one or more grooves of the assembly housing.

3. The receptacle connector of claim 1, comprising:
a board lock partially embedded in the housing and comprising one or more mounting portions extending beyond the housing in a mounting direction different from the mating direction.

4. The receptacle connector of claim 3, wherein:
the mounting direction is perpendicular to the mating direction.

5. The receptacle connector of claim 3, wherein:
the shell comprises a sidewall and a connecting portion; and
the connecting portion comprises a first end connected to a rear of the sidewall and a second end connected to the board lock such that the board lock extends next to the sidewall.

6. The receptacle connector of claim 4, wherein:
the board lock comprises a beam elongated in the mating direction and embedded in the housing; and
the one or more mounting portions extend from the beam in the mounting direction.

7. The receptacle connector of claim 1, comprising:
a sealing member disposed on the mating end of the shell.

8. The receptacle connector of claim 7, wherein:
the mating end of the shell comprises a rough portion that has a surface roughness higher than a rest of the mating end of the shell; and
the sealing member is disposed on the rough portion of the mating end of the shell.

9. The receptacle connector of claim 8, wherein:
the terminal assembly comprises an assembly housing;
a rear of the housing of the receptacle connector extends beyond the assembly housing;
the sealing member disposed on the mating end of the shell is a first sealing member; and
the receptacle connector comprises a second sealing member disposed in the rear of the housing of the receptacle connector and on a bottom wall of the shell.

10. The receptacle connector of claim 9, wherein:
the second sealing member comprises cured adhesive.

11. A receptacle connector comprising:
a terminal assembly comprising an assembly housing and a plurality of conductive elements held by the assembly housing, each of the plurality of conductive elements comprising a mating end, a tail end extending out of the assembly housing, and an intermediate portion between the mating end and the tail end;
a shell surrounding at least the mating ends and intermediate portions of the plurality of conductive elements and engaging at least a portion of the assembly housing; and
a housing disposed outside the shell and molded over a rear of the shell.

12. The receptacle connector of claim 11, wherein:
the rear of the shell comprises a bottom wall extends out of the housing; and
the receptacle connector comprises a sealing member disposed on the bottom wall of the rear of the shell.

13. The receptacle connector of claim 12, wherein:
the bottom wall of the rear of the shell comprises one or more portions protruding toward the terminal assembly; and
the sealing member comprises a side conforming to a surface of the bottom wall of the rear of the shell and other sides conforming to inner surfaces of the housing.

14. The receptacle connector of claim 13, comprising:
a pair of board locks disposed on opposite sides of the shell and partially embedded in the housing.

15. The receptacle connector of claim 14, wherein:
each of the pair of board locks comprises one or more mounting portions extending beyond the housing in a mounting direction.

16. The receptacle connector of claim 15, wherein:
the pair of board locks extend from opposite sides of the shell.

17. A method of manufacturing a receptacle connector, the method comprising:
providing a shell surrounding a cavity and comprising one or more portions protruding into the cavity;
providing a terminal assembly comprising an assembly housing and a plurality of conductive elements held by the assembly housing;
inserting the terminal assembly into the cavity of the shell; and
molding a housing over portions of the shell.

18. The method of claim 17, wherein:
molding the housing over portions of the shell comprises molding the housing over portions of a board lock.

19. The method of claim 17, comprising:
applying an adhesive between a top of the housing and a bottom of the shell; and
curing the adhesive to form a seal.

20. The method of claim 18, comprising:
subsequent to molding the housing, severing a lead frame from the shell and the board lock.
